(19) United States
(12) Patent Application Publication
(10) Pub. No.: US 2007/0201220 A1
(43) Pub. Date: Aug. 30, 2007

(54) Illuminated container

(75) Inventor: Trenton S. Ulicny, New York, NY (US)

Correspondence Address: OSTROLENK FABER GERB & SOFFEN, 1180 AVENUE OF THE AMERICAS, NEW YORK, NY, 100368403, US

(73) Assignee: Adroit Ventures, LLC, New York, NY (US)

(21) Appl. No.: 11/518,082

(22) Filed: Sep. 8, 2006

Related U.S. Application Data
(60) Provisional application No. 60/776,764, filed on Feb. 24, 2006.

(51) Int. Cl. F21V 33/00

(52) U.S. Cl. 362/101

(57) ABSTRACT

A vessel with a base unit that illuminates the beverage housing of the vessel is provided. The housing may be in the shape of a beverage bottle. The base unit may include a light source adapted to project light through the housing with a color of light coordinated with the color of a liquid in the vessel or a color of walls of the housing; and a mating surface adapted to mate with a bottom of the housing. The base unit may have a mating surface with a rounded protrusion adapted to mate with an inverted-cup shaped cavity formed in the bottom of the housing, such that the light source is in the center of the cup in the mated position. The vessel may also include a timer configured to turn off the light source a specified period of time after the light source is turned on.

### CROSS REFERENCE TO RELATED APPLICATIONS

The present application claims priority to U.S. Provisional Application No. 60/776,764, filed on Feb. 24, 2006, which is incorporated in full by reference herein.

### BACKGROUND OF THE INVENTION

1. Field of the Invention

The present invention relates to a container for holding liquids, and in particular, to an illuminated container for holding liquids.

2. Description of the Art

Containers, such as liquor bottles, are common place. As is known, bartenders will often line liquor bottles along a surface of the bar. As customers order drinks, the bartender will select one or more of the bottles, dispense liquor therefrom, and then place the bottles back onto the bar surface.

Bar and restaurant owners are often seeking ways to enhance the atmosphere of a bar. One way this has been done is to illuminate the bar surface on which the bottles are placed. By illuminating the bar surface, the bottles also appear illuminated. A similar technique has been to place the bottles on lighted discs, again, causing the bottles to appear illuminated. However, a disadvantage of these two illumination techniques is that the bottles do not remain illuminated once the bartender removes the bottles from the bar surface/discs and as the bartender dispenses liquor from the bottles.

Accordingly, it would be desirable to attach an illumination effect to the bottles so that the bottles remain illuminated when in use.

### SUMMARY

In an example embodiment, there is provided an illuminatable vessel, i.e., a vessel capable of being illuminated, and a base unit that can illuminate a vessel or a housing of a vessel. The vessel includes a housing, for example in the shape of a beverage bottle, adapted to hold liquid; a base unit that illuminates the housing, and includes a light source adapted to project light through the housing with a color of light coordinated with the color of at least one of a liquid in the vessel or a color of walls of the housing; and a mating surface adapted to mate with a bottom of the housing.

Preferably, the base unit has a mating surface that is either non-removably attachable or removably attachable to the bottom of the housing. The mating surface may be screwed on to the bottom of the housing.

In an example embodiment, the mating surface may include a rounded protrusion adapted to mate with an inverted-cup shaped cavity formed in the bottom of the housing. The light source may be arranged such that it is at or near the center of the inverted cup when the base unit is mated with the housing.

Preferably, the light source may be removably attachable to the base unit.

In an example embodiment, the base unit may include at least one side wall that is transparent to light from the light source, and may include at least one opaque side wall. It may also feature a light-reflective bottom wall.

Preferably, the base unit may further include a second light source of a color different from the color of the first light source. The base unit may also further include an integrated circuit configured to control an on and off state of the light source to produce a flashing pattern.

In an example embodiment, the vessel may also include a timer configured to turn off the light source a specified period of time after the light source is turned on. This timer may be located at the base unit.

In an example embodiment, the base unit may further include a pressure-sensitive automatic switch adapted to turn on the light source automatically when the base unit is lifted from a resting surface.

Preferably, the vessel may also include an automatic switch adapted to turn on the light source automatically when the base unit is tilted from a substantially upright position, when the base unit is substantially moved, or when a cap of the housing is at least one of removed or replaced.

In an example embodiment, the housing of the vessel may be a drinking glass or a vase.

### BRIEF DESCRIPTION OF THE DRAWINGS

FIG. 1A shows a front view of an illuminated container according to an example embodiment of the invention.

FIG. 1B shows a rear view of the illuminated container of FIG. 1A according to an example embodiment of the invention.

FIG. 1C shows a perspective view of the illuminated container of FIG. 1A according to an example embodiment of the invention.

FIG. 1D shows a top view of the illuminated container of FIG. 1A according to an example embodiment of the invention.

FIG. 1E shows a bottom view of the illuminated container of FIG. 1A according to an example embodiment of the invention.

FIG. 1F shows interior portions of the illuminated container of FIG. 1A according to an example embodiment of the invention.

FIG. 2 shows a portion of the interior of the illuminated container of FIG. 1A according to an example embodiment of the invention.

FIG. 3 shows an alternative configuration of an illuminated container according to an example embodiment of the invention.

FIG. 4 shows another alternative configuration of an illuminated container according to an example embodiment of the invention.

FIG. 5A shows a front view of an illuminated container according to another example embodiment of the invention.

FIG. 5B shows a rear view of the illuminated container of FIG. 5A according to an example embodiment of the invention.

FIG. 5C shows a top view of the illuminated container of FIG. 5A according to an example embodiment of the invention.

FIG. 5D shows a bottom view of the illuminated container of FIG. 5A according to an example embodiment of the invention.

FIG. 6A shows a front view of an illuminated container according to another example embodiment of the invention.

FIG. 6B shows a rear view of the illuminated container of FIG. 6A according to an example embodiment of the invention.

FIG. 6C shows a top view of the illuminated container of FIG. 6A according to an example embodiment of the invention.

FIG. 6D shows a bottom view of the illuminated container of FIG. 6A according to an example embodiment of the invention.

### DETAILED DESCRIPTION OF THE EMBODIMENTS

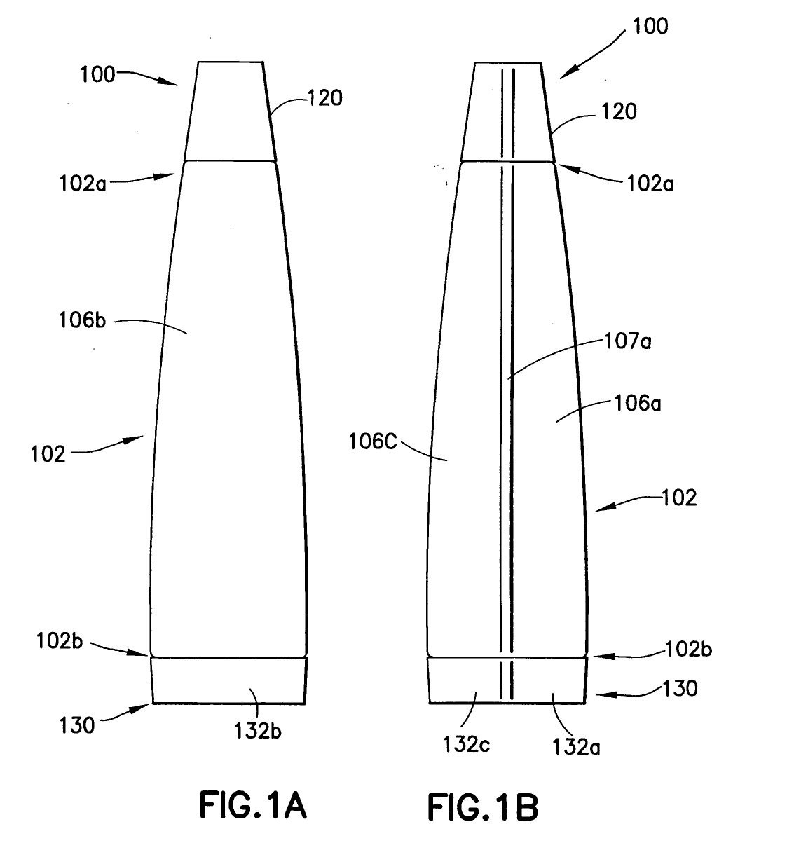

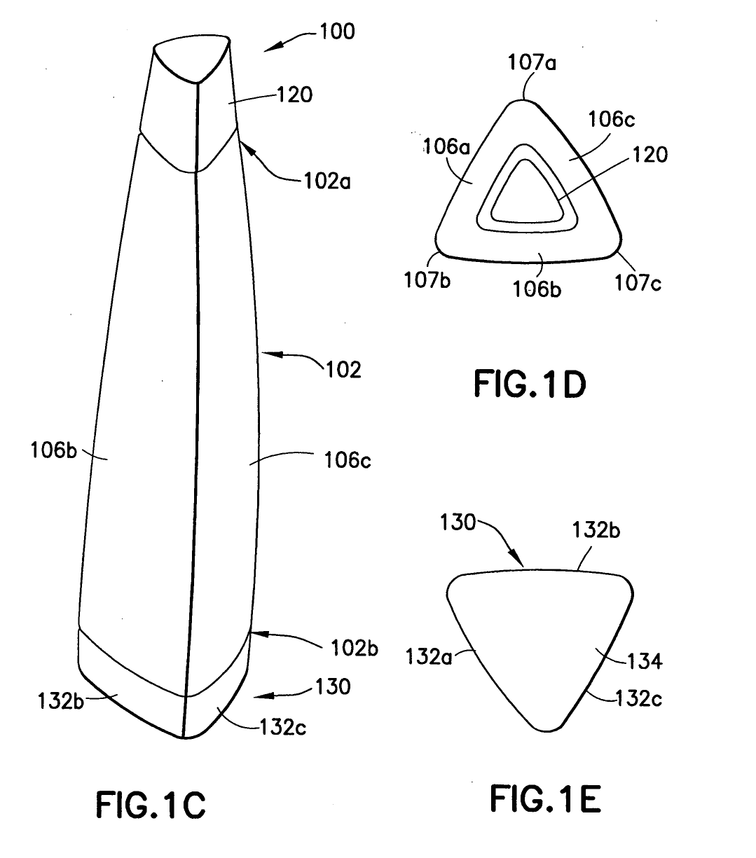

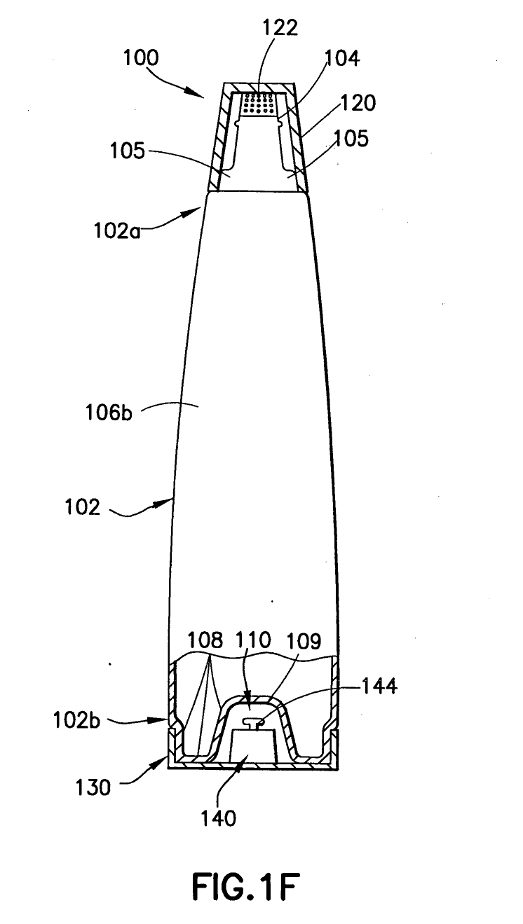

Referring to FIGS. 1A, 1B, 1C, and 1F there is shown an illuminated container 100 according to an example or preferred embodiment (“example embodiment”) of the invention. Note that FIGS. 1A, 1B, and 1C show a front view, a rear view, and a perspective view of container 100. FIG. 1F shows the same view of the container as FIG. 1A with portions of the container cut away so as to show interior portions thereof. Container 100 includes a bottle 102 having a spout 104, a cap 120 that detachably secures over spout 104, and a base unit 130 secured at a bottom end 102b of bottle 102. According to an example embodiment of the invention, base unit 130 houses a lighting unit 140 that when activated, illuminates bottle 102 from the bottom thereof, thereby causing bottle 102 to glow.

Bottle 102 is preferably a closed container configured to hold liquid therein. According to an example embodiment of the invention, bottle 102 includes three sides 106a, 106b, and 106c, as shown in FIGS. 1A, 1B, 1C and 1D, with FIG. 1D being a top view of container 100. These sides are joined at edges 107a, 107b, and 107c, thereby giving bottle 102 a triangular cross-section. Each of the sides 106a-c may have substantially the same dimensions or different dimensions. Edges 107a-c are preferably radiused or rounded. Nonetheless, these edges may have other forms including but not limited to an angular formation. In an example embodiment of the invention, sides 106a-c taper inward from the bottom end 102b of bottle 102 towards the top end 102a of the bottle. With this configuration, bottle 102 has the form of a three-sided pyramid. In an example embodiment, tapering the sides 106a-c inward as described above increases the luminescence of the bottle when lighting unit 140 is activated, thereby requiring less power output.

Bottle 102 may also include in an example embodiment an opening or spout 104 integral with sides 106a-c at the top end 102a of the bottle. Spout 104 may be configured such that a liquid may be placed into and dispensed from bottle 102. In general, spout 104 may have any shape and/or configuration. Bottle 102 may also include a base 108 integral with sides 106a-c at the bottom end 102b of the bottle. Base 108 is preferably solid thereby forming an enclosed container.

One skilled in the art will recognize that while bottle 102 preferably has a pyramid type shape as described above, the bottle may have other configurations without deviating from the invention. In an example embodiment, bottle 102 may have two sides or may have four or more sides. Similarly, the sides may not taper inward, thereby giving bottle 102 a column-like shape. Bottle 102 also does not need to include distinct sides but rather, may by one single continuous side, thereby giving bottle 102 a rounded appearance. One skilled in the art will recognize that numerous other configurations are possible.

Preferably, sides 106a-c and base 108 of bottle 102 are formed of glass, although other known materials can be used. Spout 104 may also be formed of glass, although other materials, including but not limited to metal, may be used. As further described below, lighting unit 140 of base unit 130 preferably projects light through base 108 of bottle 102 and out through sides 106a-c, thereby causing bottle 102 to glow. Accordingly, base 108 is preferably transparent or at least sufficiently translucent or shaded to allow light to enter into the interior of bottle 102. Similarly, sides 106a-c may be transparent or sufficiently translucent or shaded to allow the light to thereafter exit from the bottle. According to an example embodiment of the invention, sides 106a-c are lightly frosted on at least the exterior of bottle 102, thereby making the sides translucent. This frosting increases luminescence. In an example embodiment, sides 106a-c and/or base 108 may be clear glass (that is frosted or unfrosted) or may be glass tinted with a color (again, frosted or unfrosted), such as green.

One skilled in the art will recognize that sides 106a-c and/or base 108 do not need to be uniformly configured throughout. For example, portions of sides 106a-c may be transparent and other portions translucent. Similarly, portions of sides 106a-c may be opaque and other portions transparent/translucent. As another example, different portions of sides 106a-c may be different colors.

In addition to sides 106a-c and/or base 108 possibly being frosted, the sides and base may be substantially smooth, so not to refract the light passing therethrough, or may be cut-glass. Again, one skilled in the art will recognize that numerous other configurations are possible.

According to an example embodiment of the invention, one or more of sides 106a-c may include markings, labels, and/or printed/painted matter. As an example, such matter may be decorative patterns, trademarks, trade names, etc. This matter may or may not allow light to pass there through.

One skilled in the art will recognize that while sides 106a-c and base 108 of bottle 102 are preferably made of glass, the sides and base may be formed from any transparent, translucent, shaded, tinted, frosted etc. material known in the art, such as plastic.

Preferably cap 120 detachably secures to spout 104, thereby sealing bottle 102. The exterior shape of cap 120 may vary without deviating from the present invention. As an example and as shown in FIGS. 1B, 1C and 1D, cap 120 may have three sides that taper inward, thereby matching the shape of cap 120 to the shape of bottle 102.

Cap 120 may secure to spout 104 using any mechanism known in the art. For example, as shown in FIG. 1F, cap 120 may include an integral cork 122 disposed therein that extends perpendicularly downward within the cap. Cork 122 may be made of any suitable material known in the art including but not limited to wood, plastic, rubber, glass, metal, etc. As cap 120 is placed over spout 104, cork 122 may seat within spout 104, thereby sealing bottle 102 and also securing the cap to the bottle. Alternatively or in addition, spout 104 may include ridge 105 configured to correspond to the interior shape of cap 120, thereby forming an interference/friction fit. Alternatively, cap 120 and spout 104 may be configured such that cap 120 is a screw cap.

Cap 120 is preferably opaque so that light emanating from lighting unit 140 does not project from the spout of the bottle. Nonetheless, cap 120 may also be configured to be transparent, translucent, shaded, frosted etc. in accordance with the above discussion relating to other parts of the bottle. Depending on the configuration of cap 120, the cap may be formed from any material(s) known in the art including ABS (Acrylonitrile Butadiene Styrene) or composite plastic, glass, metal, and/or wood and may have any color. As an example, cap 120 may formed of an opaque plastic colored to have a chrome-like appearance.

One skilled in the art will recognize that container 100 does not need to include a cap 120. For example, container 100 may only include a cork 122. As another example, spout 104 may be configured such that bottle 120 is an open bottle that is not sealed.

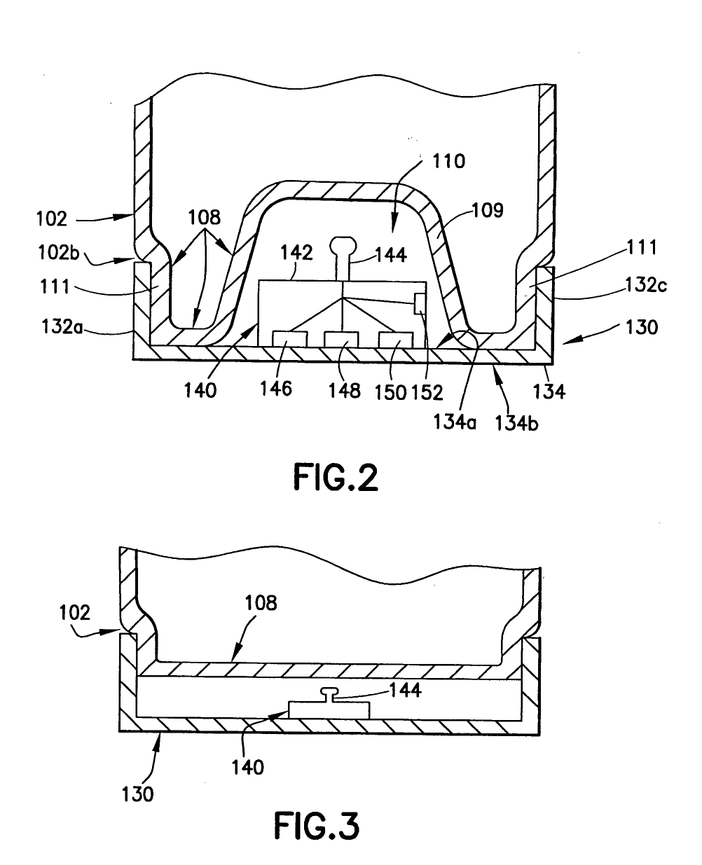

Referring now to base unit 130, according to an example embodiment of the invention, this unit is configured to house lighting unit 140 and is configured to seat over the exterior surface of base 108 of bottle 102. As shown in FIG. 2, which is a detailed cross-section of base unit 130 and a portion of bottle 102, according to an example embodiment of the invention, base unit 130 may have a cup-like configuration and in particular, may include one or more sides 132a-c, a bottom side 134 integral with sides 132a-c, and an open top side for receiving bottle 102. The exterior shape of base unit 130 may vary without deviating from the present invention. As an example and as shown in FIGS. 1B, 1C, and 1E (FIG. 1E being a bottom view of container 100), base unit 130 may have three sides 132a-c with radiused edges, thereby matching the shape of sides 106a-c of bottle 102. Bottom side 134 of base unit 130 is preferably flat on the exterior surface 134b thereof, thereby providing a stable platform for vessel 100 when placing the vessel on a surface, for example.

According to an example embodiment of the invention, base unit 130 is detachably secured to bottle 102 over the exterior surface of base 108. In this way, a user may detach base unit 130 from bottle 102 to service lighting unit 140, such as to replace a battery, for example. Base unit 130 may secure to bottle 102 using any mechanism known in the art. For example, base 108 of bottle 102 may seat within base unit 130 and include a ridge 111 configured to correspond to the interior shape of base unit 130, thereby forming an interference/friction fit. Alternatively, base unit 130 and base 108 may be configured such that the base unit 130 screws onto base 108.

According to another example embodiment of the invention, base unit 130 may be non-detachably secured to bottle 102. As an example, base 108 of bottle 102 may seat within base unit 130 and be secured thereto with an adhesive. Here, base unit 130 may include a hatch or door along bottom side 134 for example, which door may provide access to lighting unit 140. Alternatively, lighting unit 140 may seat within bottom side 134 of base unit 130 and be configured to be detachably inserted into and removed from the base unit.

Base unit 130 is preferably opaque so that light emanating from lighting unit 140 does not project through the base unit. Nonetheless, base unit 130 may also be configured to be transparent, translucent, shaded, frosted etc. in accordance with the above discussion relating to other parts of the bottle. Depending on the configuration of base unit 130, it may be formed from any material(s) known in the art including ABS or composite plastic, glass, metal, and/or wood and may have any color. As an example, base unit 130 may formed of an opaque plastic colored to have a chrome-like appearance.

According to an example embodiment of the invention, at least a portion of the interior surface of base unit 130 (such as along interior surface 134a of bottom side 134) is coated with a reflective or mirror-like substance so that light emanating from lighting unit 140 reflects into the interior of bottle 102.

Referring now to FIG. 2, lighting unit 140, according to an example embodiment of the invention, includes one or more light sources 144, a power source 146, and a switch 148. Light source 144 may be one or more LEDs and power source 146 may be one or more batteries, such as a 3-volt battery. Light source 144, power source 146, and switch 148 are operatively connected such that light source 144 illuminates through the activation of switch 148. As indicated above, lighting unit 140 is preferably housed within base unit 130. Lighting unit 140 is preferably configured such that when base unit 130 is secured to bottle 102, light source 144 is centrally positioned under the bottom side of base 108 and is configured to direct light upward through base 108 and into the interior of bottle 102. Nonetheless, other configurations are possible.

According to an example embodiment of the invention and as shown in FIGS. 1F and 2, base 108 of bottle 102 may include an inverted well 109 that extends into the interior of bottle 102, thereby forming an empty cavity 110. In general, inverted well 109 increases the illumination effect/luminescence of bottle 102. According to an example embodiment of the invention, light source 144 may be configured to be disposed at the entrance/lower end of cavity 109. According to another example embodiment of the invention and as shown in FIGS. 1F and 2, light source 144 may be configured to be disposed within cavity 110, thereby effectively positioning the light source within the interior of bottle 102. As an example, lighting unit 140 may include a pedestal 142 on which light source 144 is positioned and which places the light source into cavity 110. This configuration of light source 144 enables light emanating from the light source to travel up and down bottle 102, thereby further increasing luminescence. One skilled in the art will recognize that the depth of cavity 110 and the positioning of light source 144 within this cavity may vary. As an example, cavity 110 and light source 144 may be configured to substantially place the light source at the center of bottle 102.

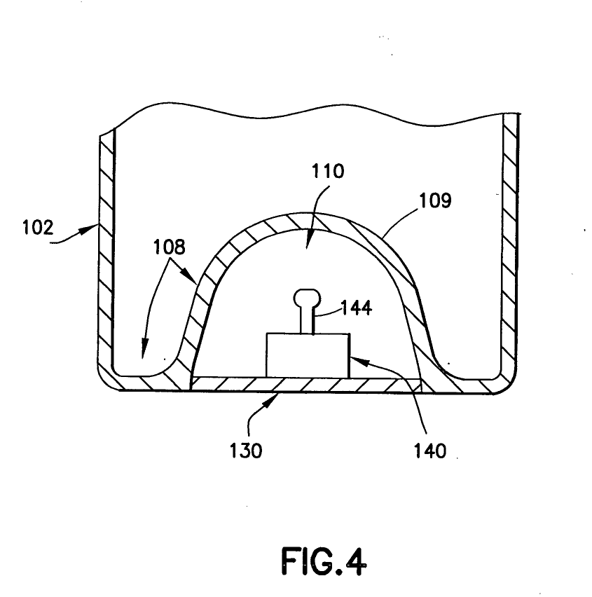

Once skilled in the art will recognize that base 108 does not need to include a cavity as shown in the figures. For example, referring to FIG. 3, base 108 may be substantially flat along the bottom side thereof and may be disposed within base unit 130 so as to reside above light source 144. One skilled in the art will also recognize that base unit 130 and lighting unit 140 may have configurations other than that described above. For example, as shown in FIG. 4, base unit 130 and bottle 102 may be configured such that base unit 130 and lighting unit 140 seat within cavity 110 of base 108 of bottle 102.

Switch 148, according to an example embodiment of the invention, may be a manually operated switch accessible from bottom side 134 of base unit 130 and that allows a user to turn light source 144 on and off as desired. Alternatively and/or in addition, lighting unit 140 may also include a timer 150 that automatically turns light source 144 off after a predetermined time limit, such as 10 seconds.

According to another example embodiment of the invention, switch 148 may be a pressure type switch that extends from bottom side 134 of base unit 130 and is activated through contact with a surface on which vessel 100 is placed. For example, picking up vessel 100 may cause switch 148 to turn light source 144 on and placing vessel 100 back down may cause switch 148 to turn light source 144 off. Alternatively, lighting unit 140 may also include a timer 150 such that placing vessel 100 onto a surface does not turn light source 144 off. Rather, the light source may remain illuminated for a predetermined time limit until turned off by the timer.

According to another example embodiment of the invention, switch 148 may be configured as a pendulum mechanism that turns light source 144 on when vessel 100 is tilted, for example, and turns light source 144 off when vessel 100 is up-righted. Similarly, switch 148 may be configured as a motion switch that turns light source 144 on when vessel 100 is moved. Again, a timer 150 may be included with either of these configurations.

According to another example embodiment of the invention, switch 144 may be integrated with the removal and replacement of cap 120. One skilled in the art will recognize that other variations are possible.

According to another example embodiment of the invention, lighting unit 140 may also include an integrated circuit 152 thereby forming an intelligent light source 144. For example, integrated circuit 152 may be configured to cause light source 144 to illuminate in flashed patterns for example. Assuming lighting unit 140 includes a plurality of light sources 144, integrated circuit 152 may cause the light sources to illuminate in patterns.

According to an example embodiment of the invention, light source 144 may be emit a white light or may emit a colored light. According to an example embodiment of the invention, the color of light source 144 may be coordinated with the color of the liquid within container 102 and/or coordinated with the color of sides 106a-c. In this way, the appearance of vessel 100 is directly affected and enhanced. As an example, the color of light source 144 may be matched to the color of the liquid within container 102 and/or matched to the color of sides 106a-c. In this way, the light output of vessel 100 may be maximized.

According to an example embodiment of the invention, base unit 130/lighting unit 140 may be non-detachable from bottle 102 so that the bottle and base unit are purchased as a single system. According to another example embodiment of the invention, base unit 130 may be detachable from bottle 102. With this configuration, a bartender for example, may purchase a plurality of bottles 102 and a single base unit 130. Here, the bartender may attach base unit 130 to the bottle presently being used. When the bottle is empty, the bartender may discard the bottle and secure base unit 130 to a new bottle.

According to another example embodiment of the invention, base unit 130/lighting unit 140 may be configured and sold in a plurality of standard sizes and shapes corresponding to commercially sold bottles. In this fashion, a bartender for example, may attach a base unit to any commercially sold bottle as desired. As an example, each base unit may be configured to attach to a bottle using an interference/friction fit.

One skilled in the art will recognize that the present invention may be applied to numerous types of containers. For example, the invention may be applied to liquor bottles (as described above), soda bottles, decanters, etc. The invention may also be applied to personal use containers such as beer bottles and water bottles. The invention may also be applied to drinking glasses. Similarly, the invention may be applied to containers not used to hold consumer beverages, such as vases. One skilled in the art will recognize that the invention is not limited to these example applications.

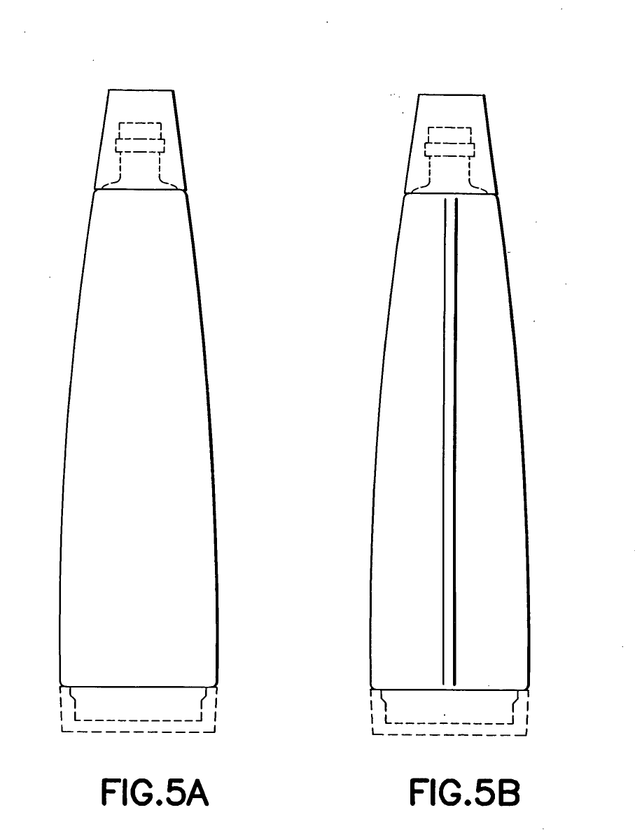

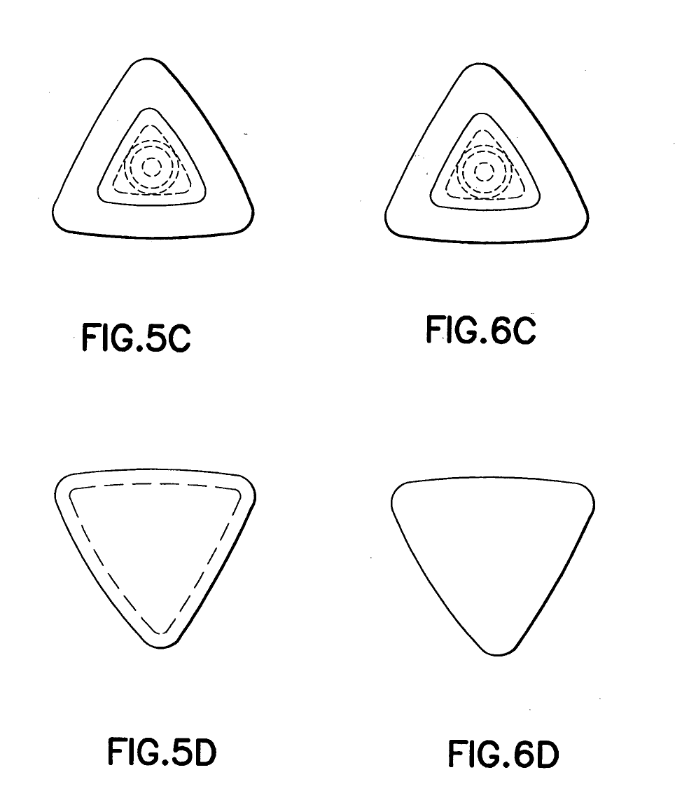

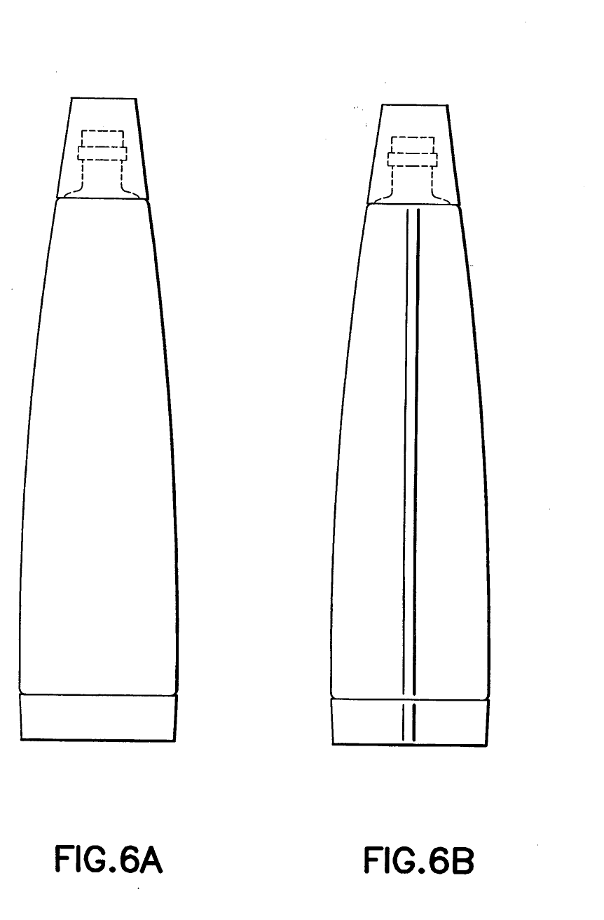

Referring to FIGS. 5A, 5B, 5C, and 5D there is shown an illuminated container according to another example embodiment of the invention. Referring to FIGS. 6A, 6B, 6C, and 6D there is shown an illuminated container according to a further example embodiment of the invention. Note that FIGS. 1A-1E, FIG. 5A-5D, and FIGS. 6A-6D correspond to figures in a co-filed design application (U.S. Design Application Serial No. 29/254,614, filed Feb. 24, 2006) by the inventor of the present application, the contents of which are incorporated by reference herein.

Although the present invention has been described in relation to particular embodiments thereof, many other combination of features, variations and modifications and other uses will become apparent to those skilled in the art.

What is claimed is:

1. An illuminatable vessel comprising:
a housing adapted to hold liquid; and
a base unit configured to illuminate the housing, the base unit including:
a light source adapted to project light through the housing with a color of light coordinated with the color of at least one of a liquid in the vessel or a color of walls of the housing; and
a mating surface adapted to mate with a bottom of the housing.

2. The vessel of claim 1, wherein the mating surface is non-removably attachable to the bottom of the housing.

3. The vessel of claim 1, wherein the mating surface is removably attachable to the bottom of the housing.

4. The vessel of claim 1, wherein the mating surface is adapted to be screwed on to the bottom of the housing.

5. The vessel of claim 1, wherein the mating surface comprises a rounded protrusion adapted to mate with an inverted-c up shaped cavity formed in the bottom of the housing.

6. The vessel of claim 1, wherein the light source is removably attachable to the base unit.

7. The vessel of claim 1, the base unit further comprising at least one side wall transparent to light from the light source.

8. The vessel of claim 1, the base unit further comprising at least one opaque side wall.

9. The vessel of claim 1, the base unit further comprising a light-reflective bottom wall.

10. The vessel of claim 1, the base unit further comprising a second light source of a color different from the color of the first light source.

11. The vessel of claim 1, the base unit further comprising an integrated circuit configured to control an on and off state of the light source to produce a flashing pattern.

12. The vessel of claim 1, wherein the housing comprises a beverage bottle.

13. An illuminatable vessel comprising:
a housing adapted to hold liquid; and
a base unit configured to illuminate the housing, the base unit including:
a light source adapted to project light through the housing; and
a rounded protrusion adapted to mate in a removable manner with an inverted-c up shaped cavity formed in the bottom of the housing, such that the light source is provided substantially at a center of the inverted-cup shaped cavity inside the rounded protrusion when the housing and the base unit are in mating position.

14. The vessel of claim 13, wherein the light source is adapted to shine a color of light coordinated with the color of at least one selected from the group consisting of a liquid in the housing and a color of the walls of the housing.

15. The vessel of claim 13, wherein the housing comprises a beverage bottle.

16. An illuminatable vessel comprising:
a housing adapted to hold liquid; and
a base unit configured to illuminate the housing, the base unit including:
a light source adapted to project light through the housing;
a mating surface adapted to mate in a removable manner with a bottom of the housing; and
a timer configured to turn off the light source a specified period of time after the light source is turned on.

17. The vessel of claim 16, wherein the mating surface comprises a rounded protrusion adapted to mate in a removable manner with an inverted-cup shaped cavity formed in the bottom of the housing, such that the light source is provided substantially at a center of the inverted-cup shaped cavity inside the rounded protrusion when the housing and the base unit are in mating position.

18. The vessel of claim 16, wherein the light source is operable to project a color of light coordinated with the color of at least one selected from the group consisting of a liquid in the housing and a color of the walls of the housing.

19. The vessel of claim 16, wherein the housing comprises a beverage bottle.

20. An illuminatable vessel comprising:
a housing adapted to hold liquid; and
a base unit configured to illuminate the housing, the base unit having:
a light source adapted to project light through the housing;
a rounded protrusion adapted to mate with an inverted-cup shaped cavity formed in the bottom of the housing, such that the light source is arranged substantially at a center of the inverted-cup shaped cavity inside the rounded protrusion when the housing and the base unit are in mating position; and
a timer configured to turn off the light source a specified period of time after the light source is turned on.

21. The vessel of claim 20, wherein the base unit further comprises a pressure-sensitive automatic switch adapted to turn on the light source automatically when the base unit is lifted from a resting surface.

22. The vessel of claim 20, further comprising an automatic switch adapted to turn on the light source automatically when the base unit is tilted from a substantially upright position.

23. The vessel of claim 20, further comprising an automatic switch adapted to turn on the light source automatically when the base unit is substantially moved.

24. The vessel of claim 20, further comprising an automatic switch adapted to turn on the light source automatically when a cap of the housing is at least one of removed or replaced.

25. The vessel of claim 20, wherein the light source is adapted to output a color of light coordinated with the color of at least one selected from the group consisting of a liquid in the housing and a color of the walls of the housing.

26. The vessel of claim 20, wherein the housing comprises a beverage bottle.

27. An illuminatable vessel comprising:
a housing adapted to hold liquid;
a base unit having a light source adapted to shine a color of light coordinated with the color of at least one of a liquid in the housing or a color of walls of the housing, and a rounded protrusion adapted to mate in a removable manner with an inverted-cup shaped cavity formed in the bottom of the housing, such that the light source is provided substantially at a center of the inverted-cup shaped cavity inside the rounded protrusion when the housing and the base unit are in mating position;
a timer configured to turn off the light source a specified period of time after the light source is turned on; and
a pressure-sensitive automatic switch adapted to turn on the light source automatically when the base unit is lifted from a resting surface.

29. The vessel of claim 27, wherein the base unit comprises opaque sidewalls of a similar outer appearance and color as the sidewalls of the vessel.

30. The vessel of claim 27, wherein the base unit comprises an integrated circuit and a second light source emitting light of a color different from the first light source, the light source and the second light source controlled by the integrated circuit to produce a flashing pattern comprising lights of different colors.

31. The vessel of claim 27, wherein the housing comprises a beverage bottle.

32. The vessel of claim 27, wherein the housing comprises a drinking glass.

33. The vessel of claim 27, wherein the housing comprises a vase.

34. A base unit configured to illuminate a housing, the base unit comprising:
a light source adapted to shine a color of light coordinated with the color of at least one of a liquid in the housing or a color of walls of the housing, and a rounded protrusion adapted to mate in a removable manner with an inverted-cup shaped cavity formed in the bottom of the housing, such that the light source is provided substantially at a center of the inverted-cup shaped cavity inside the rounded protrusion when the housing and the base unit are in mating position;
a timer configured to turn off the light source a specified period of time after the light source is turned on; and
a pressure-sensitive automatic switch adapted to turn on the light source automatically when the base unit is lifted from a resting surface.

35. The base unit of claim 34, further comprising opaque sidewalls of a similar outer appearance and color as the sidewalls of the vessel.

36. The base unit of claim 34, further comprising an integrated circuit and a second light source emitting light of a color different from the first light source, the light source and the second light source controlled by the integrated circuit to produce a flashing pattern comprising lights of different colors.
